(19) United States
(12) Patent Application Publication
(10) Pub. No.: US 2009/0107781 A1
(43) Pub. Date: Apr. 30, 2009

(54) Vibration Damper Having a Rebound Buffer

(75) Inventors: Michael FRITZ, Breckerfield (DE); Uwe Klein, Wuppertal (DE)

Correspondence Address: CROWELL & MORING LLP;INTELLECTUAL PROPERTY GROUP, P.O. BOX 14300, WASHINGTON, DC, 20044-4300, US

(73) Assignee: ThyssenKrupp Bilstein Suspension GmbH, Ennepetal (DE)

(21) Appl. No.: 12/237,762

(22) Filed: Sep. 25, 2008

(30) Foreign Application Priority Data
Sep. 25, 2007 (DE) 102007045892.6

(51) Int. Cl. F16F 9/49; B60G 13/04

(52) U.S. Cl. 188/280

(57) ABSTRACT

A vibration damper for the wheel suspension of a motor vehicle includes a damping tube, a working piston which splits the interior of the damping tube into two working chambers and is attached to a piston rod, a closure assembly which closes an open end of the damping tube and through which the piston rod is guided, and a rebound buffer spring which is disposed between two spring plates. The rebound buffer spring is formed as a helical spring, wherein the ends of the rebound buffer spring are supported on support surfaces of the spring plates. The spring plates comprise support sleeves extending in the longitudinal direction of the vibration damper, and the outer peripheral surfaces of the support sleeves support the rebound buffer spring from the inside in the radial direction when the rebound buffer spring has reached its hard stop. The support sleeves do not touch when the compression coil spring is at its hard stop.

This application claims the priority of German patent application 10 2007 045 892.6, filed Sep. 25, 2007, the disclosure of which is expressly incorporated by reference herein.

### BACKGROUND OF THE INVENTION

The invention relates to a vibration damper for the wheel suspension of a motor vehicle having a mechanical rebound buffer which is formed by a rebound buffer spring formed as a helical spring and disposed between two spring plates. The ends of the rebound buffer spring are supported on corresponding support surfaces of the spring plates.

A vibration damper of this type which comprises the features of the preamble of claim 1 is known for example from DE 10 2005 009 213 A1. It is also known from this document that the rebound buffer spring can buckle towards the inner wall of the damping tube, in particular when large amounts of spring travel have to be provided for design reasons. To obviate this undesired buckling of the rebound buffer spring, it is proposed that the inner diameter of the helical spring windings is reduced in a central spring portion, so that buckling occurs towards the piston rod and the rebound buffer spring lies against the piston rod during buckling. As a result, the piston rod acts as a radial guide for the rebound buffer spring. A disadvantage of this solution is that the rebound buffer spring has to be shaped in a particular way in order to achieve the desired inward buckling, i.e., towards the piston rod. Simpler, cylindrical springs which are favourable to produce in terms of cost can therefore not be used. An additional disadvantage is that the piston rod surface can be damaged by the rebound buffer spring.

In addition to the outward buckling of the rebound buffer spring towards the damping tube discussed in DE 10 2005 009 213 A1, practice has shown that when the rebound buffer spring reaches its hard stop owing to large forces acting on it, the individual windings of the rebound buffer spring formed as a helical spring can slide within each other. The spring windings yield outwardly or inwardly in the radial direction so that the fact that the individual spring windings slide within each other means that the spring plastically deforms when the force acting thereon is sufficiently strong. The operation and creep resistance of the rebound buffer spring is then no longer provided. No countermeasures are disclosed in DE 10 2005 009 213 A1 in relation to this undesired plastic deformation of the rebound buffer spring which induces a technical failure.

Publication EP 1 591 690 A1 describes a hydraulic vibration damper for motor vehicles (see, in particular, FIG. 2 and the associated description) in which the rebound buffer spring (compression coil spring 31) supports itself on the flange 24a of a support pipe 24. The length of the support pipe is dimensioned in accordance with paragraph 0033 of this publication so that it is equal to or greater than the minimum length of the rebound buffer spring at its elastic limit, i.e., when it reaches its hard stop. This means for the object of EP 1 591 690 A1 that the rebound buffer spring cannot be loaded beyond its hard stop point and compressed. Because either the support pipe is longer than the hard stop of the spring, then the support pipe 24 comes to rest against the stopper 32 before the rebound buffer spring actually reaches its hard stop. Or the support pipe 24 is as long as the hard stop of the rebound buffer spring, in which case the spring can at best reach its hard stop but cannot be loaded beyond it. In both cases, all forces are dissipated via the support pipe 24, the stopper 32, the rebound buffer 33, and the cylinder cover 13. No critical forces that can cause overload and plastic deformation can therefore act on the rebound buffer spring 31.

An important disadvantage of the design known from EP 1 591 690 A1 is that the support pipe 24 with the spring plate shaped flange 24a can be subjected to very high loads if great spring plate forces occur when the vibration dampers rebound, e.g., in vehicles with a high weight and off-road properties. The support pipe in this design must therefore consist of a material that can bear the occurring loads, surface pressures and tensions without plastic deformation. This is because in practice very small tolerances are permissible between the piston rod and the spring plate that supports the rebound buffer spring while plastic deformation of the spring plate can rapidly result in damage to the piston rod. Plastic deformation of the spring plate should be prevented even if very great spring plate forces occur when the vehicle rebounds. Materials with a low specific weight such as plastic or light metal (e.g., aluminum) which a designer would like to use for the spring plate to reduce weight can therefore not be used with the design known from EP 1 591 690 A1.

DE 100 21 762 A1 represents Prior Art which does not relate to the technical subject matter of the present invention but rather relates only in the broadest sense to the technical field of damping movements of components. This document discloses an air damper for a movably mounted component in a car (e.g., a glove compartment flap). A helical spring is disposed in the cylinder of the air damper. This helical spring is not a rebound buffer spring in the sense of the present invention but rather should impart a preferential adjustment direction to the cylinder. The cylinder and piston of the air damper known from DE 100 21 762 A1 are formed from synthetic material.

DE 100 21 762 A1 discusses the problem that said spring disposed in the cylinder interior can cause certain problems, in particular acoustic problems. The spring is described as being relatively unstable so that upon actuation thereof the buckling threshold is reached very quickly. If the spring buckles, it produces undesired knocking, rubbing and buzzing noises. To avoid this, DE 100 21 762 A1 proposes that diametrically longitudinal ribs are formed on the piston rod, wherein the windings of the spring lie against the ribs when the spring is released. The solution disclosed in DE 100 21 762 A1 is not applicable to the technical field of the present invention, i.e., the field of vibration dampers for wheel suspensions in motor vehicles having mechanical rebound buffers, since in the case of these vibration dampers which are exposed to high forces during operation the piston rod is always formed as a metal rod having a peripheral surface (which is generally hard-chromium plated). Forming longitudinal ribs on the piston rod as taught in DE 100 21 762 A1 does not therefore come into consideration.

Based on Prior Art as represented by DE 10 2005 009 213 A1, it is the object of the invention to further develop a vibration damper in accordance with the preamble of claim 1 in such a manner that plastic deformation of the compression coil spring can be reliably obviated even when the compression coil spring reaches its hard stop owing to the extremely high forces acting on it and is further loaded at its hard stop. At the same time, it shall be possible to make the spring plate that supports the compression coil spring from a material with a low specific weight and thus to reduce weight.

### SUMMARY OF THE INVENTION

The invention is based on the knowledge that, in particular in the case of vehicles having a large weight and off-road properties, extremely large rebound buffer forces can occur when the vibration damper rebounds. It is completely normal that the rebound buffer forces in such vehicles can assume values of up to 45 kN and even higher. However, conventional rebound buffer springs already reach their hard stop with much lower forces in dependence upon their spring rate. Common rebound buffer forces, which cause the rebound buffer springs to reach their hard stop, can be for example in the range between 2 and 6 kN. If a rebound buffer force acting on the spring exceeds the force value at which the spring reaches its hard stop, then these forces act on the spring which has reached its hard stop. This can then lead to the individual windings of the rebound buffer spring yielding in the radial direction, i.e., the windings slide within each other. As a result, the spring is plastically deformed which leads to a loss of operation or to a failure of the spring.

Based on the aforementioned knowledge, it is proposed in accordance with the invention to provide the spring plates, on which the ends of the rebound buffer spring are supported on support surfaces, in addition to these support surfaces with a further functional surface, i.e., with support sleeves extending in the axial direction (i.e., in the longitudinal direction of the vibration damper), the outer peripheral surfaces of which completely support the rebound buffer spring radially inwards when the rebound buffer spring reaches or has reached its hard stop. The idea in accordance with the invention thus resides in the fact that an additional function, i.e., the function of radially supporting the rebound buffer spring from the inside, is integrated into the spring plates supporting the rebound buffer spring in the axial direction.

According to the invention, the support sleeves do not touch when the rebound buffer spring has reached its hard stop so that all occurring axial forces are absorbed and dissipated by rebound buffer spring at its hard stop. Since the rebound buffer spring is made of steel, it can absorb extremely high axial forces when at its hard stop because it is supported from inside and in radial direction by the support sleeves. This prevents buckling out or telescoping of the spring coils even if very high axial forces occur.

Since the support sleeves of the spring plates do not touch when the spring is at its hard stop, the support sleeves do not absorb any axial forces. Therefore, the spring plates with the support sleeves can advantageously be made of a material with a low specific weight such as plastic or aluminum.

In accordance with a preferred embodiment of the invention, the axial extension of the support sleeves is dimensioned such that the rebound buffer spring which has reached its hard stop is substantially supported over its entire length radially from the inside by the peripheral surfaces of the support sleeves. The present invention is particular effectively implemented when the diameter of the rebound buffer spring is dimensioned such that in the released state it only has a relatively small spaced disposition from the inner wall of the damping tube. Simultaneously, the diameters of the support sleeves are to be dimensioned in dependence upon the diameter of the rebound buffer spring such that it is guaranteed that the rebound buffer spring is radially supported from the inside, when the rebound buffer spring has reached its hard stop. With the rebound buffer spring and the support sleeves dimensioned with respect to each other in such manner, there is an enclosed annular space when the rebound buffer spring has reached its hard stop, in which the rebound buffer spring is held in a secure manner with respect to buckling and deformation. The individual spring windings cannot slide within each other and the spring cannot plastically deform as a result.

Other objects, advantages and novel features of the present invention will become apparent from the following detailed description of the invention when considered in conjunction with the accompanying drawings.

### BRIEF DESCRIPTION OF THE DRAWINGS

FIG. 1 shows in detail an axial, half-sectional view of a vibration damper having a rebound buffer in accordance with the invention in the released state of the rebound buffer spring;

FIG. 2 shows in detail an axial, half-sectional view of a vibration damper having a rebound buffer in accordance with the invention when the rebound buffer spring has reached its hard stop.

### DETAILED DESCRIPTION OF THE DRAWINGS

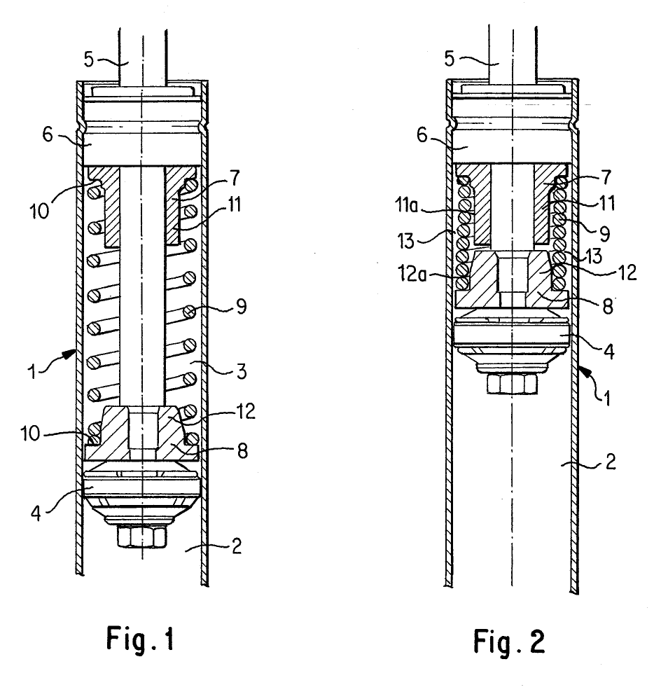

FIG. 1 illustrates the rebound buffer in accordance with the invention in a released state of the rebound buffer spring 9. The rebound buffer spring 9 is supported with its two ends on support surfaces 10 of the spring plates 7, 8. The spring plate 7 for its part is supported on the surface of the closure assembly 6 facing the working chamber 3 and is disposed on the piston rod 5 so as to be able to move in the axial direction. The other spring plate 8 is screwed onto a threaded pin of the piston rod 5 and is consequently fixedly connected thereto. Alternatively, the lower spring plate 8 can also be positioned on the piston rod pin and clamped by a piston nut, or be secured to the slide way by crimping, by using a snap ring or by welding (however, these alternatives are not illustrated in the Figures). The working piston 4 is attached to a piston rod pin via a nut.

The rebound buffer spring 9 is dimensioned relative to the inner diameter of the damping tube 1 such that in the released state of the spring, only a small spaced disposition is provided between the rebound buffer spring 9 and the inner wall of the damping tube 1. The end of the rebound buffer spring 9 remote from the working piston 4 is supported in the axial direction on a support surface 10 of the spring plate 7. Simultaneously, the spring plate 7 comprises a support sleeve 11 which extends in the longitudinal direction of the vibration damper. The diameter of the support sleeve 11 is dimensioned relative to the diameter of the rebound buffer spring 9 such that the outer peripheral surface 11a of the support sleeve 11 radially supports the rebound buffer spring 9 from the inside when the rebound buffer spring 9 has reached its hard stop (cf. FIG. 2).

This is also true for the support sleeve 12 of the spring plate 8 allocated to the working piston 4. The spring plate 8 also comprises a support sleeve 12 extending in the longitudinal direction of the vibration damper, the peripheral surface 12a of the support sleeve radially supporting the rebound buffer spring 9 from the inside when the spring has reached its hard stop (cf. FIG. 2). In the illustrated exemplified embodiment, the peripheral surface 12a is not simply cylindrically formed, like the peripheral surface 11a of the spring plate 7, but rather has a slightly conical shape. Starting from the support surface 10 of the spring plate 8, on which the end of the rebound buffer spring 9 is supported, the diameter of the support sleeve 12 tapers in the axial direction. This conical shape of the peripheral surface 12a enables the support sleeve 12 to be inserted more easily into the rebound buffer spring 9 and prevents jamming of the rebound buffer spring 9 on the support sleeve 9.

The diameters of the support sleeves 11 and 12 of the spring plates 7, 8 and the diameter of the rebound buffer spring 9 are dimensioned such that when the rebound buffer spring 9 reaches its hard stop, an enclosed annular space 13 is formed between the inner wall of the damping tube 1 and the peripheral surfaces 11a, 12a of the support sleeves 11, 12, in which space the rebound buffer spring 9 is held in a secure manner with respect to buckling and deformation. Owing to the enclosed arrangement of the rebound buffer spring 9, which has reached its hard stop, in the annular space 13, the situation where individual windings of the rebound buffer spring 9 can yield in the radial direction and can be slid within each other when high forces act thereon is reliably obviated. In this manner, plastic deformation of the rebound buffer spring 9 is also reliably prevented when the forces acting on the rebound buffer spring exceed the force at which the rebound buffer spring 9 reaches its hard stop by a multiple factor.

As mentioned before, FIG. 2 shows the rebound buffer spring 9 in its hard stop position. It is well visible that the support sleeves 11, 12 do not touch. The high axial forces are not absorbed and dissipated via the support sleeves 11, 12 but via the rebound buffer spring 9 at its hard stop. In this way, plastic deformation of the support sleeves 11, 12 due to axial forces cannot occur. The spring plates 7, 8 may therefore be made of a material that has a considerably lower specific weight than steel. In particular, lightweight materials such as plastic or light metal (such as aluminum) can be used for producing the spring plates 7, 8 so that the weight can be reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1. Damping tube
2. Working chamber
3. Working chamber
4. Working piston
5. Piston rod
6. Closure assembly
7. Spring plate
8. Spring plate
9. Rebound buffer spring
10. Support surface
11. Support sleeve
11a. Peripheral surface
12. Support sleeve
12a. Peripheral surface
13. Enclosed annular chamber

What is claimed is:

1. Vibration damper for the wheel suspension of a motor vehicle, having a damping tube, a working piston which splits the interior of the damping tube into two working chambers and is attached to a piston rod, a closure assembly which closes an open end of the damping tube and through which the piston rod is guided, and having a rebound buffer spring which is disposed between two spring plates and is formed as a helical spring, wherein the ends of the rebound buffer spring are supported on support surfaces of the spring plates, wherein the spring plates comprise support sleeves extending in the longitudinal direction of the vibration damper, the outer peripheral surfaces of the support sleeves supporting the rebound buffer spring from the inside in the radial direction when the rebound buffer spring has reached its hard stop, and wherein the support sleeves do not touch when the compression coil spring is at its hard stop.

2. Vibration damper as claimed in claim 1, wherein the axial extensions of the support sleeves are dimensioned such that when the rebound buffer spring has reached its hard stop, the rebound buffer spring is supported over its entire length by the support sleeves.

3. Vibration damper as claimed in claim 1, wherein the diameter of the rebound buffer spring is dimensioned relative to the diameter of the damping tube and the diameters of the support sleeves are dimensioned relative to the diameter of the rebound buffer spring such that when the rebound buffer spring has reached its hard stop an annular chamber is formed in which the rebound buffer spring is disposed in a secure manner with respect to buckling and deformation.
